(19) United States
(12) Patent Application Publication
(10) Pub. No.: US 2024/0147981 A1
(43) Pub. Date: May 9, 2024

(54) POINT OF INTEREST SPRAY SYSTEM

(71) Applicant: EXEL INDUSTRIES, EPERNAY (FR)

(72) Inventor: Arthur Margerit, Saint-Cyr-sur-Morin (FR)

(21) Appl. No.: 18/500,377

(22) Filed: Nov. 2, 2023

(30) Foreign Application Priority Data
Nov. 5, 2022 (FR) 2211522
May 1, 2023 (FR) 2304375

(51) Int. Cl. A01M 7/00; A01C 23/00

(52) U.S. Cl. CPC A01M 7/0089; A01C 23/007

(57) ABSTRACT

The present invention is directed to a localized spray system, comprising a spray boom, at least one optical sensor and a control system, the control system being configured to process images acquired from the field of view, detect at least one point of interest and associate said point of interest with location data in a reference frame of the spray boom, the location data being continuously updated via a calculation system of the control system, depending on the movement of said spray boom, and to control said at least one spray nozzle depending on said at least one point of interest, such that when said location data correspond to a sprayable zone, the control system controls opening of the nozzle(s) corresponding to said zone of interest to spray the point of interest.

### TECHNICAL HELD

The present invention relates to the field of agricultural spraying and, more precisely, localized spraying using an agricultural machine, depending on location data sensed in real time. The invention relates in particular to a spray system via nozzles controlled depending on images acquired of a zone to be treated, as well as an associated method.

### BACKGROUND

The purpose of agricultural spraying is to apply different treatment products to crops, generally aimed at increasing their growth, yield and/or quality. Treatment products can especially be used to weed, control disease, insect or pest infestation, and provide the nutrients required for proper crop development.

A spray system conventionally comprises at least one tank arranged to contain a treatment product, possibly diluted, a spray boom comprising a plurality of spray sections each equipped with a nozzle or a plurality of spray nozzles, and a hydraulic circuit connecting the tank to the different spray sections. The spray boom generally extends along a transverse axis relative to a longitudinal direction in which the agricultural machine travels over the plot. The hydraulic circuit may especially comprise a pump arranged to suck treatment product into the tank and lead it to the spray boom, and a pressure regulator arranged to maintain the pressure in the hydraulic circuit at a predetermined threshold pressure. Each spray nozzle is arranged to spray treatment product over a predetermined width of the plot defined along the transverse axis, Each nozzle, or plurality of nozzles, is thus associated with a sprayable zone on the ground, substantially corresponding to a geometric shape, such as a disk, an oval or, approximately, a rectangle, onto which it is possible to deliver treatment product. The sprayable zone associated with each nozzle or plurality of nozzles naturally changes with the movement of the spray system.

With the objective of reducing the amount of treatment product applied, spray systems have been adapted to enable localized treatment of plots.

By localized treatment, it is meant spraying the product only on zones of the plot that actually require treatment. To this end, each spray section is controlled, for example by means of a dispenser arranged to assume an open position, in which a circulation of the product from the tank to the corresponding spray nozzle is possible, and a closed position, in which said circulation is blocked. The different dispensers can especially be controlled individually. In general, each spray section can be controlled individually by means of a suitable control unit.

The spray system also comprises an image acquisition system and a control unit. The image acquisition system is mounted to the agricultural machine and comprises at least one camera arranged to acquire images of the plot a few seconds before the nozzles of the spray system pass. Generally, it comprises a plurality of cameras distributed along a second transverse axis relative to the longitudinal direction, so as to cover the entire width likely to be treated by the spray system. The control unit is configured to determine effective zones to be treated using real-time image processing performed on the images acquired by the image acquisition system, and to control each of the dispensers individually according to the effective zones to be treated.

In particular, spray systems comprising a plurality of cameras arranged on the spray boom of the system are known. The cameras are configured to detect a point of interest in the cameras' field of view. The point of interest is a zone to be sprayed, for example due to the presence of biotic stressors. A spray system of the state of the art cuts the plots in the field of view of the cameras into a plurality of sectors, and places the point(s) of interest, that is especially the zone(s) containing biotic stressors, in one or more sectors, respectively. Once the points of interest have been associated with sectors, the agricultural machine moves to those sectors and the spray sections will be controlled in an open or closed position, so as to deliver the treatment product only to the sectors identified as being to be treated.

However, when the agricultural machine makes a turn, sectoring the plots is carried out again. The sectors of the initial sectoring do not correspond to the sectors of the new sectoring. It is then no longer possible to know which sector has been sprayed, which sector has not and this can then result in multiple spraying of one sector or non-spraying of another sector, for example.

The purpose of the present invention is therefore to provide a solution for allowing localized spraying by marking points of interest in the field of view of the spray system, locating said points of interest and allowing their spraying regardless of the trajectory or movement of the agricultural machine.

### SUMMARY OF THE INVENTION

More precisely, one object of the invention is a localized spray system, comprising a spray boom, at least one spray nozzle arranged on the spray boom, said spray nozzle being associated with a sprayable zone, at least one optical sensor and a control system, each optical sensor having a field of view, the control system being configured to process images acquired from the field of view, detect at least one point of interest and associate said point of interest with location data in a reference frame of the spray boom, the location data being continuously updated via a calculation system of the control system, depending on the movement of said spray boom, and to control said at least one spray nozzle depending on said at least one point of interest, such that, when the location data of the point of interest correspond to a sprayable zone, the control system controls opening of the spray nozzle(s) corresponding to said sprayable zone to spray the point of interest.

Especially, the optical sensor comprises at least one depth camera configured to allow obtaining three-dimensional location data of the points of interest.

Advantageously, the spray system comprises a set of nozzles, each of the nozzles being associated with a sprayable zone and each of the nozzles being controlled such that, when the location data of a point of interest correspond to the sprayable zone of a nozzle with which it is associated, the control system controls opening of said spray nozzle to spray said point of interest.

More advantageously, the spray system comprises a set of nozzles forming groups of nozzles corresponding to spray sections, each of the groups of nozzles being associated with a sprayable zone and each of the groups of nozzles being controlled depending on the point of interest associated therewith, such that when the location data of the point of interest correspond to the sprayable zone of a group of nozzles with which it is associated, the control system controls opening of said group of spray nozzles to spray said point of interest.

Preferably, the spray system comprises a set of nozzles forming groups of nozzles, each group of nozzles being controlled independently of each other by the control system.

Still preferably, the spray system is configured to process the images acquired from the field of view, detect at least one point of interest, and associate said point of interest with location data in a reference frame of the spray boom.

In particular, the control system implements rules for activating the spray nozzle: depending on conditions, especially in addition to the condition of the presence of the point of interest in a sprayable zone, the activation rules may comprise the possibility of activating a spray nozzle to deliver treatment product, deactivating a spray nozzle to not deliver treatment product; when a nozzle is activated, an activation rule may provide determining a specific dose of treatment product to be applied.

The invention also relates to a method for spraying a product to be sprayed by means of a spray system as briefly described above, carried or trailed by an agricultural machine, wherein the control system:
processes the images acquired from the field of view by the optical sensor;
detects at least one point of interest;
associates said point of interest with location data in a reference frame of the spray boom;
controls said at least one spray nozzle depending on said at least one point of interest; such that, when the location data of the point of interest correspond to a sprayable zone, the control system controls opening of the corresponding spray nozzle to spray the point of interest considered.

The control system of the spray system continuously determines, by means of the adapted calculation system, the location data of the points of interest to be treated, depending on the movement of the spray boom moving forward, turning, etc.

Advantageously, the control system further associates said point of interest with a dose of product to be sprayed.

### BRIEF DESCRIPTION OF THE DRAWINGS

The invention will be better understood upon reading the following description, given solely as an example, and by referring to the accompanying figures, given as non-limiting examples, wherein identical references are given to similar objects and in which;

FIG. 1 is a schematic representation of the spray system according to the invention.

FIG. 2 is a schematic representation of the spray system according to the invention in operation.

It should be noted that the figures set out the invention in detail in order to enable the implementation of the invention; although non limiting, said figures are especially used to better define the invention where applicable.

### DETAILED DESCRIPTION

The invention relates to a localized spray system. The spray system is carried by an agricultural machine 15 allowing different treatment products to be sprayed on crops, generally aimed at increasing their growth, yield and/or quality. In particular, the treatment products to be sprayed can be used to treat biotic stressors present in crops.

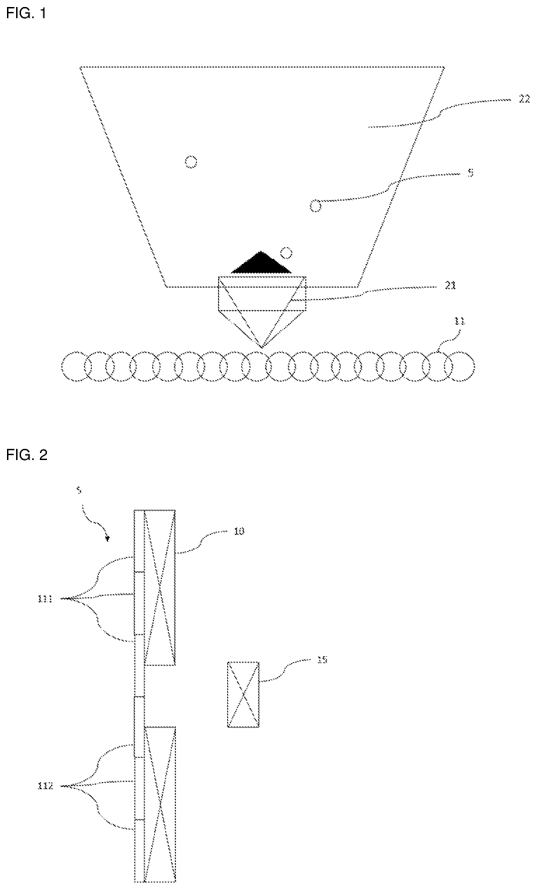

The spray system comprises a spray boom 10, at least one spray nozzle, at least one optical sensor 21 and a control system. The reference signs are shown facing the attached schematic FIGS. 1 and 2.

The spray boom 10 comprises at least one nozzle, generally a set of nozzles.

The set of spray nozzles is arranged on the spray boom 10 and each nozzle or group of nozzles is associated with a sprayable zone 11.

The nozzles of the set of nozzles are thus either independent of each other or form groups of nozzles and are divided into spray sections.

The set of nozzles is especially configured to allow the sprayable zone 11 to be adjustable. Indeed, a nozzle taken independently allows spraying on a circular zone. A group of nozzles taken together can allow spraying on an oval or substantially rectangular area, for example.

The optical sensor 21 has a field of view 22 and each point of the field of view can be associated with location data.

According to one embodiment, the optical sensor 21 is configured to enable obtaining two-dimensional location data, in particular for any point of interest 5 detected in an image.

According to another embodiment, the optical sensor 21 may comprise at least one depth camera configured to enable obtaining three-dimensional location data.

The control system is configured to process images acquired from the field of view 22, detect at least one point of interest 5, and associate the point of interest 5 detected with location data in a reference frame of the spray boom 10.

To locate a point of interest 5 in an acquired image, the optical sensor 21 can implement a beam passing through its optical center and through the point of interest 5 to be located.

The control system is also configured to control the set of spray nozzles depending on said at least one point of interest 5, such that when the location data of the point of interest 5 corresponds to a sprayable zone 11 of the set of nozzles, the control system controls opening of the corresponding nozzle or group of spray nozzles, to spray the point of interest 5 in question.

In particular, the control system may control a spray nozzle or a group of spray nozzles depending on each of the points of interest 5 identified. For example, if the point of interest 5 is extended, the system for controlling the spray system will control a group of nozzles, corresponding to the sprayable zone in which the point of interest 5 extended will be.

In case of a small point of interest 5, the control system will preferably control a spray nozzle independently.

According to one embodiment, the spray system can adapt the number of nozzles to be activated and/or the dose of treatment product delivered by each nozzle, so as to adapt to each of the points of interest 5.

When the spray system comprises a plurality of nozzles independent of each other, each of the nozzles is associated with a sprayable zone 11 and each of the nozzles is controlled depending on the point of interest 5 associated therewith. Thus, when the location data of the point of interest 5 correspond to the sprayable zone 11 of a nozzle or a group of nozzles with which it is associated, the control system controls opening of the nozzle or group of spray nozzles to spray the point of interest 5 considered.

When the spray system comprises a set of nozzles forming groups of nozzles, each of the groups of nozzles is thus associated with a sprayable zone 11 and each of the groups of nozzles is controlled independently. Thus, when the location data of the point of interest correspond to the sprayable zone 11 of a group of nozzles with which it is associated, the control system controls opening of the group of spray nozzles to spray the point of interest 5 considered.

For example, with reference to FIG. 2, the agricultural machine 15 trails or carries the spray boom 10 which comprises spray nozzles or groups of spray nozzles respectively associated with the sprayable zones 111 and 112, here rectangular. The points of interest 5 are marked by analyzing images acquired by the optical sensor(s) 21 disposed on the spray boom 10. The points of interest 5 are associated with location data in the reference frame of the optical sensor 21 first, then in the reference frame of the spray boom 10 because the relative positions of the optical sensors 21 on the boom 10 are predefined.

The control system comprises a memory that hosts a database in which all information relating to the points of interest 5, including their location data, is stored.

Still with reference to FIG. 2, when the agricultural machine 15 and spray boom 10 move, the database is updated by a calculation system that transposes the location data depending on the movement of the agricultural machine 15 and spray boom 10. The calculation system compares the location data to the sprayable zones 111, 112. Thus, when the location data of the points of interest 5 correspond to a sprayable zone 111, 112, the corresponding nozzle or group of spray nozzles is activated to treat the point of interest considered.

Thus, with reference to FIG. 2, the sprayable zones 111, in which the points of interest 5 are at the time instant considered, are treated by activating the corresponding spray nozzles. Conversely, the sprayable zones 112 do not comprise a point of interest 5 and the corresponding spray nozzles are deactivated at the time instant considered.

According to one embodiment, the control system is configured to process the images acquired from the field of view 22 of the optical sensor 21 (or the fields of view from the various optical sensors distributed on the spray boom, where applicable), detect at least one point of interest 5 and associate the point of interest and the corresponding dose with location data in the reference frame of the spray boom 10.

The invention further relates to a method for spraying a treatment product to be sprayed by means of the spray system carried by an agricultural machine 15.

In the spraying method, the system for controlling the spray system processes the images acquired from the field of view 22 by the optical sensor 21, then detects at least one point of interest 5. Then, it associates the point of interest 5 with location data in a reference frame of the spray boom 10 and controls the at least one spray nozzle, in particular in terms of activation or deactivation and, where applicable, of the dose to be applied, depending on the point of interest. Finally, when the location data of the point of interest 5 correspond to a sprayable zone 11 (or 111 and 112 in FIG. 2), the control system controls opening of the spray nozzle or group of spray nozzles to spray the zone.

The spray system takes account of the movements of the spray boom when establishing the location data of the point(s) of interest.

Furthermore, in the spraying method, the control system may associate the point of interest 5 with a dose of treatment product to be sprayed before associating the point of interest 5 and the corresponding dose with location data in a reference frame of the spray boom 10. The product dose is calculated by an activation function after an activation rule is validated.

In this way, the control system can identify elements to be treated, in particular the points of interest 5. In particular, the control system may make it possible to identify biotic stressors present in the crops in the images acquired from the field of view 22, The biotic stressors identified then form one or more points of interest 5. The control system then associates location data with each of the points of interest 5 identified in a reference frame of the spray boom 10.

The control system can also assign characteristics to the points of interest 5, for example characteristics relating to its size, shape or the reliability of the detection and the dose of treatment product to be applied, where applicable.

According to the invention, each image acquired by the optical sensor(s) 21 distributed on the spray boom 10 is thus processed globally: location data is assigned to each point of interest (corresponding to an element to be treated), the location data being two-dimensional or preferably three-dimensional.

To obtain three-dimensional location data, the optical sensor 21 can be equipped with a depth camera.

The advantage of three-dimensional location data lies in the greater efficiency of location and therefore of spraying, especially on non-planar or sloping or inclined plots, or plots comprising curves, or in the case of high elements to be treated.

As already discussed, the location data of the points of interest 5 to be treated are determined, in the reference frame of the optical sensor 21 first, then in the reference frame of the spray boom 10. Because they are predefined, the relative positions of the optical sensors 21 on the spray boom 10 are indeed known.

Furthermore, the spray system may comprise a satellite position sensor, of the GPS type, to know the position of the spray boom 10 and allow easy transposition of the location data of the points of interest 5 into the reference frame of the spray boom 10.

The system for controlling the spray system continuously determines, by means of the adapted calculation system, the location data of the points of interest 5 to be treated, depending on the movement of the spray boom 10 which moves forward, turns, etc. The calculation system thus comprises an adapted processor, especially capable of performing computations on floating numbers.

For this purpose, the control system stores, in its memory managed as a buffer, the database comprising the points of interest 5 to be treated and the associated information, including the location data of these points of interest 5 to be treated, the location data being continuously updated depending on the movement of the spray boom 10 and the new images acquired from the field of view 22.

Next, it is determined when points of interest 5 to be treated enter sprayable zones and the corresponding spray nozzle(s) is/are activated.

According to one embodiment, the control system implements rules for activating the spray nozzles: depending on conditions, in particular in addition to the condition of the presence of the point of interest 5 in a sprayable zone, the activation rules may comprise the possibility of activating a spray nozzle to deliver the treatment product, deactivating a spray nozzle not to deliver the treatment product; when a nozzle is activated, an activation rule may provide for setting a specific dose of treatment product to be applied.

The activation rules can take account of the surface area of biotic stressors present at the point of interest 5 to be treated, their size or even an index of confidence in the identification made by image processing.

By means of the invention, the spray system makes it possible to achieve the following advantages.

First, the information allowing the decision to activate a nozzle by the control system is not broadcast over a sector, but concentrated on a point, such as the points of interest 5 represented in FIG. 1.

Secondly, the invention is not limited to two-dimensional location.

The invention also makes it possible to manage a diagonal movement of the spray system relative to a previous trajectory, without the risk of double treatment or omission of points of interest.

Besides, the invention allows easy implementation of turn compensation means, by conventional linear algebra calculations.

Management of the dynamics of the spray nozzles is further improved.

The present invention facilitates the adaptation of the doses of product applied depending on the detection, by possibly taking account of additional parameters on the biotic stressors identified (size, number, surface area, etc.).

The invention also allows better management of the overlap between adjacent spray nozzles.

By means of the invention, it is possible to produce a detection map of points to be treated independently of a grid resolution, as is the case when sectoring the field of view of the optical sensors.

Also, the optical sensors can be installed more freely, that is, distributed laterally in the direction or opposite to the direction of advance of the spray boom, or even diagonally to the direction of advance, because the location data of the points of interest 5 are determined in the global image acquired and is transposed into the reference frame of the spray boom 10.

In other words, the invention makes it possible to identify the zones to be sprayed as points in the reference frame of the spray boom 10.

Where applicable, each point of interest 5 can be associated with additional properties in addition to its location data (two-dimensional or three-dimensional), especially:
its detection surface area (in mm2);
an algorithmic detection confidence index (RN);
a type of element to be treated (thistle, alfalfa, etc.);
a wording (height, stage, non-sprayable, etc.);
an image identifier, that is, a number of the image in which the element to be treated has been detected, in order to detect multiple detections.

The properties of the point of interest can be used to implement activation rules.

As already stated, the advantage of locating points of interest in an image, without sectoring, is especially to be able to use the tools of the linear algebra to take account of the multiple rotations or translations of the spray system. Movements can also be translations between two measured GPS positions, an integrated acceleration over time, or even the measurement of a speed by an external sensor, especially.

Sprayable surfaces are represented by simple geometric shapes such as: circle, oval, rectangle, triangle, semi-circle. The sprayable zones, associated with a nozzle or a group of spray nozzles, can be adapted depending on the situation. The intrinsic parameters of geometric shapes are variable in real time, depending on the situation.

For example:
the length of a rectangular sprayable zone or the radius of a circular sprayable zone depends on the movement speed of the spray boom.
the radii of the oval-shaped sprayable zones are a function of the boom height;
the position of the geometric shape is adapted depending on the clearance of the spray boom;
the position of the geometric shape is adapted depending on the slope;
etc.

According to the invention, points to be treated are detected, they are located and their appearance is detected in a sprayable zone which is then treated, especially depending on activation rules, where applicable.

In this case, an activation rule is a condition that, when validated, activates spraying through a nozzle or a group of spray nozzles, possibly with a specific dosage.

For example, an activation rule can be:
three points of interest are detected, with a given confidence index and image numbers; and at least one point of interest has a size larger than 3 mm².

So, still as an example:
the control system calculates the maximum of the sum of the surface areas of the points of interest present at a given time instant in a sprayable zone based on a detection in a same image number, divides it by the surface area of the sprayable zone and multiplies it by a ratio of treatment product to be applied per unit of plot surface area;
the control system calculates the dose of treatment product to be applied and activates the corresponding nozzle(s).

Dose determination may also take account of a piece of information of treatment product amount remaining in the corresponding treatment product tank of the spray system to increase or decrease the applied dose.

Of course, the parameters taken into account to be associated with the points of interest, the number and complexity of activation rules or even the number of different treatment products applicable are not limited to the examples given, the person skilled in the art being able to adapt them to their need.

1. A localized spray system, comprising a spray boom, at least one spray nozzle arranged on the spray boom, said spray nozzle being associated with a sprayable zone, at least one optical sensor and a control system, each optical sensor having a field of view, the control system being configured to process images acquired from the field of view, each optical sensor comprising at least one depth camera configured to allow obtaining three-dimensional location data of the points of interest, the control system being configured to detect at least one point of interest and to associate said point of interest with location data in a reference frame of the spray boom, the location data being continuously updated via a calculation system of the control system, depending on the movement of said spray boom, and to control said at least one spray nozzle depending on said at least one point of interest, such that, when the location data of the point of interest correspond to a sprayable zone, the control system controls opening of the spray nozzle(s) corresponding to said sprayable zone to spray the point of interest.

2. The spray system according to claim 1, comprising a set of nozzles, each of the nozzles being associated with a sprayable zone and each of the nozzles being controlled such that, when the location data of a point of interest correspond to the sprayable zone of a nozzle with which it is associated, the control system controls opening of said spray nozzle to spray said point of interest.

3. The spray system according to claim 1, comprising a set of nozzles forming groups of nozzles corresponding to spray sections, each of the groups of nozzles being associated with a sprayable zone and each of the groups of nozzles being controlled depending on the point of interest associated therewith, such that when the location data of the point of interest correspond to the sprayable zone of a group of nozzles with which it is associated, the control system controls opening of said group of spray nozzles to spray said point of interest.

4. The spray system according to claim 3, comprising a set of nozzles forming groups of nozzles, each group of nozzles being controlled independently of each other by the control system.

5. The spray system according to claim 1, wherein the control system is configured to process the images acquired from the field of view, detect at least one point of interest and associate said point of interest with the location data in a reference frame of the spray boom.

6. The spray system according to claim 2, wherein the control system is configured to process the images acquired from the field of view, detect at least one point of interest and associate said point of interest with the location data in a reference frame of the spray boom.

7. The spray system according to claim 3, wherein the control system is configured to process the images acquired from the field of view, detect at least one point of interest and associate said point of interest with the location data in a reference frame of the spray boom.

8. A method for spraying a product to be sprayed by means of a spray system according to claim 1, carried or traded by an agricultural machine, wherein the control system:
processes the images acquired from the field of view by the optical sensor;
detects at least one point of interest;
associates said point of interest with location data in a reference frame of the spray boom;
controls said at least one spray nozzle depending on said at least one point of interest; such that, when the location data of the point of interest correspond to a sprayable zone, the control system controls opening of the corresponding spray nozzle to spray the point of interest considered.

9. The spraying method according to claim 8, wherein the control system further associates said point of interest with a dose of product to be sprayed.
